(19) United States
(12) Patent Application Publication
(10) Pub. No.: US 2006/0070544 A1
(43) Pub. Date: Apr. 6, 2006

(54) Planographic printing plate feeding apparatus

(76) Inventors: Yoshinori Kawamura, Kanagawa (JP); Yoshihiro Koyanagi, Kanagawa (JP); Masahiko Kondoh, Hertfordshire (GB); George Howell, Hertfordshire (GB)

Correspondence Address: TAIYO CORPORATION, 401 HOLLAND LANE, #407, ALEXANDRIA, VA, 22314, US

(21) Appl. No.: 11/223,990

(22) Filed: Sep. 13, 2005

(30) Foreign Application Priority Data
Sep. 15, 2004 (GB) 0420536.5

(51) Int. Cl. B41F 27/12; B41L 47/14

(52) U.S. Cl. 101/477

(57) ABSTRACT

A guide member is provided at a downstream side of a stack of plates in a direction in which a planographic printing plate is conveyed. The guide member abuts a leading edge of an uppermost planographic printing plate to be conveyed, and bends the planographic printing plate, and further, permits the uppermost planographic printing plate and an interleaf paper adhering thereto in such a manner as to be inclined by being pressed by the planographic printing plate.

### CROSS-REFERENCE TO RELATED APPLICATIONS

This application claims priority under 35 USC 119 from Great Britain Patent Application No. 0420536.5, the disclosure of which is incorporated by reference herein.

### BACKGROUND OF THE INVENTION

1. Field of the Invention

The present invention relates to a planographic printing plate feeding apparatus, and particularly to a planographic printing plate feeding apparatus in which sets of planographic printing plate and an interleaf paper are fed out one set at a time from a stack of alternately stacked planographic printing plates and interleaf papers.

2. Description of the Related Art

Generally, there are many cases in which planographic printing plates, each with a protective interleaf paper closely adhering to an image recording surface thereof, are stacked in the direction of the thickness thereof, thereby forming a stack of planographic printing plates. When an image is to be recorded on a planographic printing plate using an exposure apparatus or the like, it is necessary that planographic printing plates are taken out from the stack one by one, and fed to the exposure apparatus.

For example, Japanese Patent Application Laid-Open (JP-A) No. 60-202028 discloses the technique in which an interleaf paper is fed out by a roller, and a planographic printing plate is fed out by a vacuum pad. However, in this structure in which planographic printing plates and interleaf papers are taken out separately one by one, the next planographic printing plate can be taken out only after the interleaf paper has been removed, hence feeding of the plates takes a significant amount of time. In addition, separate discharging mechanisms are required for offtaking the planographic printing plates and interleaf papers, and so an increase in the number of parts, size, and cost of the apparatus is likely to result.

Accordingly, a method in which a set made up of a planographic printing plate and an interleaf paper, is conveyed by a roller (combined feeding) could be considered. In this case, however, two or more sets of planographic printing plates with interleaf papers might be conveyed at a time (multiple feeding), depending on the air flow between planographic printing plates, and other like factors.

In order to prevent multiple feeding, for example, a structure could be considered in which a plate (separation plate) is provided, so as to restrict movement of all planographic printing plates other than the uppermost. The separation plate acts by making contact with all the planographic printing plates, other than the uppermost one, on the downstream side of the stack, with respect to the direction in which the planographic printing plate is conveyed. However, since it is necessary that the separation plate should be brought into contact with only the planographic printing plates other than the uppermost one, a high degree of accuracy is required for the mounting of the separation plate.

### SUMMARY OF THE INVENTION

In view of the aforementioned circumstances, a planographic printing plate feeding apparatus according to the present invention comprises: a conveyor that conveys an uppermost planographic printing plate and an interleaf paper adhering thereto, by rotating while pressing a stack in which planographic printing plates and interleaf papers are alternately stacked; and a guide member provided at the downstream side of the stack, with respect to the direction in which the planographic printing plate is conveyed. The guide member is provided so as to abut the leading edge of the uppermost planographic printing plate being conveyed, so as to bend the planographic printing plate, and allow the uppermost planographic printing plate and interleaf paper to pass over the guide member, while the guide member is being inclined due to being pressed by the planographic printing plate.

In the planographic printing plate feeding apparatus according to the present invention, the conveyor conveys a planographic printing plate and an interleaf paper by rotating while pressing the stack. Ideally, only the uppermost planographic printing plate and an interleaf paper adhering thereto are conveyed (combined feeding) by the conveyor. However, if the uppermost planographic printing plate and the underlying planographic printing plate closely adhere to each other with a vacuum effect, or if air flows into a region below the underlying planographic printing plate, plural sets of planographic printing plates and interleaf papers adhering thereto might be conveyed simultaneously (multiple conveying).

In order to prevent multiple conveying, a structure could be considered providing a stopping member at the downstream side, with respect to the direction in which the planographic printing plate is conveyed, of the planographic printing plate stack. The stopping member could abut all layers in the stack other than the uppermost planographic printing plate and an interleaf paper adhering thereto. This would stop the conveying of planographic printing plates and interleaf papers adhering thereto, stacked below the uppermost planographic printing plate and the interleaf paper adhering thereto. However, in order that the stopping member is disposed so as not to abut the uppermost printing plate nor interleaf paper to be conveyed, and yet to abut against the underlying planographic printing plates, a high degree of accuracy is required for mounting. This makes production of the stopping member difficult.

Accordingly, the planographic printing plate feeding apparatus of the present invention is provided with guide members that also abut the uppermost planographic printing plate. Since the guide members may be allowed to abut the uppermost planographic printing plate, no high degree of accuracy is required for mounting.

When the uppermost planographic printing plate with an interleaf paper adhering thereto, and the underlying planographic printing plate with an interleaf paper adhering thereto are conveyed by the conveyor, the leading edge of the uppermost planographic printing plate abuts the guide members provided at the downstream side, with respect to the conveying direction, and the plate is bent. As a result, air flows into a region between the uppermost planographic printing plate and the underlying planographic printing plate. Due to the inflow of air, the uppermost planographic printing plate and interleaf paper adhering thereto can be easily separated from the underlying planographic printing plate and interleaf paper adhering thereto.

When the uppermost planographic printing plate and interleaf paper adhering thereto are further conveyed by the conveyor from the aforementioned state, the guide members permits the passing of the uppermost planographic printing plate and interleaf paper adhering thereto, while the guide is being inclined due to being pressed by the uppermost planographic printing plate. As a result, the uppermost planographic printing plate and the interleaf paper adhering thereto are conveyed to the downstream side of the guide members, with respect to the conveying direction. However, due to the air space being formed between the uppermost planographic printing plate and interleaf paper adhering thereto, and the underlying planographic printing plate and interleaf paper adhering thereto, the underlying planographic printing plate and interleaf paper adhering thereto are separated from the uppermost planographic printing plate and interleaf paper adhering thereto. This underlying plate and interleaf paper are hence left at the upstream side of the guide members with respect to the conveying direction and the plate is left in a state in which it abuts the guide members.

According to the present invention, it is possible to enable reliable conveying for the uppermost planographic printing plate and interleaf paper adhering thereto, by using guide members of a simple structure that require no high degree of accuracy in mounting.

### BRIEF DESCRIPTION OF THE DRAWINGS

FIG. 1 is a side view showing a planographic printing plate feeding apparatus according to an embodiment of the present invention.

FIG. 2 is a perspective view showing a mounting section and a discharging section of the planographic printing plate feeding apparatus according to the embodiment of the present invention.

FIG. 3 is a perspective view showing a stack of plates to be placed in the planographic printing plate feeding apparatus according to the embodiment of the present invention.

FIG. 4A is a schematic side view showing a leading edge guide and a stack of plates in a state in which a pick-up roller is brought into contact with a planographic printing plate prior to conveying.

FIG. 4B is a schematic side view showing a state in which two sets of planographic printing plates and interleaf papers are made to abut the leading edge guide after conveying has been started.

FIG. 4C is a schematic side view showing a state in which the leading edge guide is being rotated, and the uppermost planographic printing plate and interleaf paper adhering thereto are being curved.

FIG. 4D is a schematic side view showing a state in which the uppermost planographic printing plate and interleaf paper adhering thereto are passing over the leading edge guide.

FIG. 4E is a schematic side view showing a state in which the leading edge guide returns towards the stack of plates, and the second uppermost planographic printing plate and interleaf paper adhering thereto are also returned towards the stack of plates.

FIG. 5 is a diagram showing, when seen from the top, the relationship corresponding to FIG. 4A between the leading edge guides and a stacked set of planographic printing plate and interleaf paper to be fed into the planographic printing plate feeding apparatus.

FIG. 6 is a diagram showing, when seen from the top, the relationship corresponding to FIG. 4B between the leading edge guides and a stacked set of planographic printing plate and interleaf paper to be fed into the planographic printing plate feeding apparatus.

FIG. 7A is a schematic side view showing the leading edge guide and the stack of plates in a state in which a pick-up roller is brought into contact with a planographic printing plate prior to conveying of the planographic printing plate in a planographic printing plate feeding apparatus according to another embodiment of the present invention.

FIG. 7B is a schematic side view showing a state in which two sets of planographic printing plates and interleaf papers are made to abut the leading edge guide after starting conveying in the planographic printing plate feeding apparatus according to another embodiment of the present invention.

FIG. 7C is a schematic side view showing a state in which the leading edge guide is being flexed and the uppermost planographic printing plate and interleaf paper adhering thereto are being bent in the planographic printing plate feeding apparatus according to another embodiment of the present invention.

FIG. 7D is a schematic side view showing a state in which the uppermost planographic printing plate and interleaf paper adhering thereto are passing over the leading edge guide in the planographic printing plate feeding apparatus according to another embodiment of the present invention.

FIG. 7E is a schematic side view showing a state in which the leading edge guide is being returned towards the stack of plates and the underlying planographic printing plate and interleaf paper adhering thereto are also being returned towards the stack of plates.

### DETAILED DESCRIPTION OF THE INVENTION

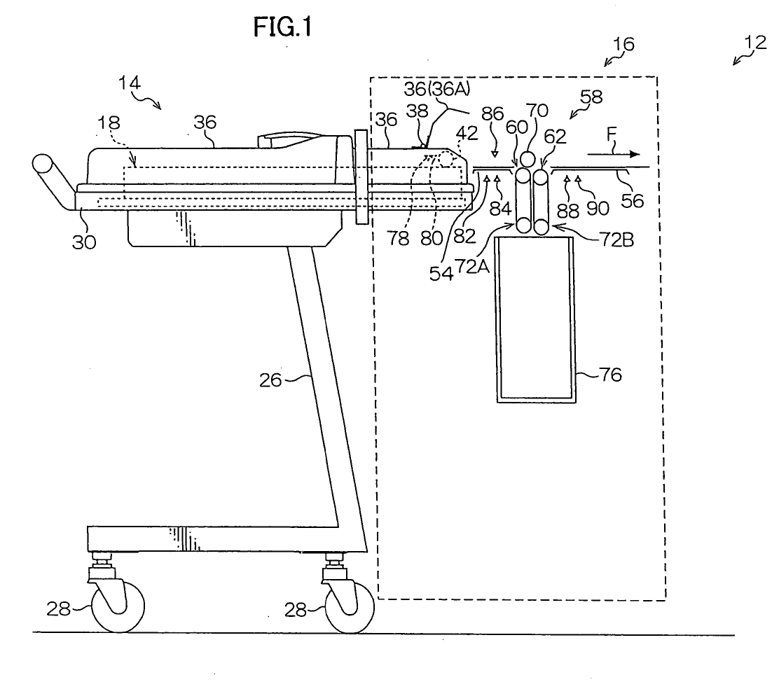

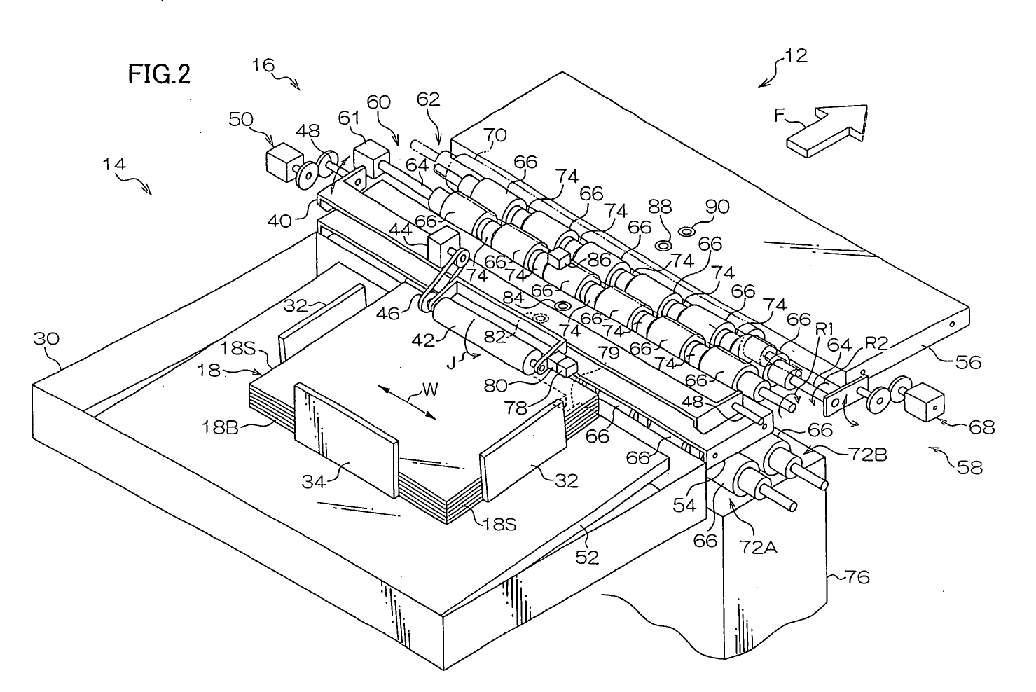

FIG. 1 shows an overall structure of a planographic printing plate feeding apparatus 12 according to the present invention. Further, FIG. 2 shows a mounting section 14 and a discharging section 16 of the planographic printing plate feeding apparatus 12, with a stack of plates 18 being mounted on the mounting section 14.

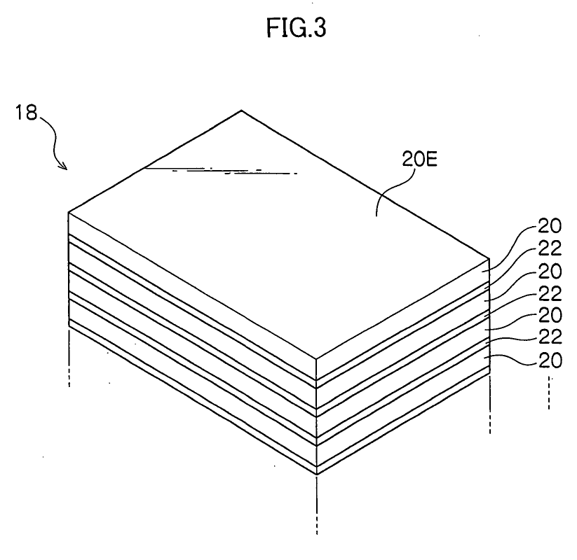

As shown in FIG. 3, the planographic printing plate 20 is formed by applying a photosensitive agent onto one surface of a supporting base that is formed from aluminum or the like, to form a photosensitive surface 20E. Interleaf papers 22 that protect the photosensitive surfaces 20E, and the planographic printing plates 20 are stacked alternately to form the stack of plates 18. FIG. 3 shows a state in which the planographic printing plates 20 are stacked such that the photosensitive surfaces 20E face upwards, and the interleaf paper 22 that protects the photosensitive surface 20E of the uppermost planographic printing plate 20 is already removed.

As shown in FIG. 1, the planographic printing plate feeding apparatus 12 is provided with a stand section 26, and the mounting section 14 and the discharging section 16 are disposed on the stand portion 26. The stand section 26 is fitted with castors 28, and the castors 28 enable the entire planographic printing plate feeding apparatus 12 to move. This enables the apparatus 12 to be inserted or withdrawn from, for example, a planographic printing plate insertion portion of an exposure apparatus.

As shown in FIG. 2, the mounting section 14 has a flat rectangular mounting tray 30. Disposed in the mounting tray 30 are two side edge guide plates 32 and one trailing edge guide plate 34. The side edge guide plates 32 slide by a sliding mechanism (not shown) in the directions indicated by a double-headed arrow W, and are aligned with the side surfaces of the stack of plates 18 (formed from a plurality of stacked sets 24), according to the size of the planographic printing plates 20. Similarly, the trailing edge guide plate 34 slides by a sliding mechanism (not shown) in the direction indicated by arrow F (and in a direction opposite thereto), and is aligned with the trailing edge of the stack of plates 18.

As shown in FIG. 1, a plurality of covers 36 are provided in the mounting portion 14 so as to cover the area around the mounted stack of plates 18. The cover 36A: covers the end portion of the stack 18 at the downstream side, with respect to the direction in which the planographic printing plate is conveyed; and, when inserted in an exposure apparatus or the like is pressed upward by a pressing member (not shown), rotates around a hinge 38, and flies up. This state is shown in FIG. 1.

As shown in FIG. 2, a holder 40 is placed to span over the mounting section 14 in the widthwise direction of the stack of plates 18. A pick-up roller 42 is mounted rotatably in the holder 40 so as to be located above the stack of plates 18 mounted on the mounting section 14. The driving force of the driving motor 44 acts on the pick-up roller 42 via an endless belt 46, so that the pick-up roller 42 rotates in the direction of conveying the planographic printing plate 20 (and the interleaf paper 22). This direction will be hereinafter referred to as “forward rotation” and indicated by arrow J. The direction in which the planographic printing plate 20 is discharged is indicated by arrow F (and will be hereinafter referred to as “conveying direction F”). “Widthwise” as used above is the direction orthogonal thereto, that is the widthwise direction parallel to the leading edge of the planographic printing plates 20, and is indicated by arrow W (which will be hereinafter referred to as “widthwise direction W”).

The holder 40 is made rotatable around supporting shafts 48 which are provided at both ends thereof in the widthwise direction W and on the downstream edge of the holder 40 with respect to the conveying direction F. Due to a rotational driving force from a driving unit 50 provided at the side of the holder 40, the pick-up roller 42 is rotated between: a conveying position in which it comes into contact with the stack of plates 18, with a predetermined load acting thereon; and a separated position in which the pick-up roller 42 is moved away from the stack of plates 18.

The bottom of the mounting tray 30 is formed as a mounting plate 52 that swings due to a hinge (not shown) provided at the upstream side of the mounting plate 52 with respect to the conveying direction F. The mounting plate 52, on which the stack of plates 18 is mounted, is urged upwards by an urging member (not shown), ensuring that the uppermost planographic printing plate 20 reliably comes into contact with the pick-up roller 42.

Two guide plates 54 and 56 are disposed sequentially at the downstream side of the mounting portion 14 at predetermined intervals in the conveying direction F. The planographic printing plate 20 is conveyed while being supported by the guide plates 54 and 56.

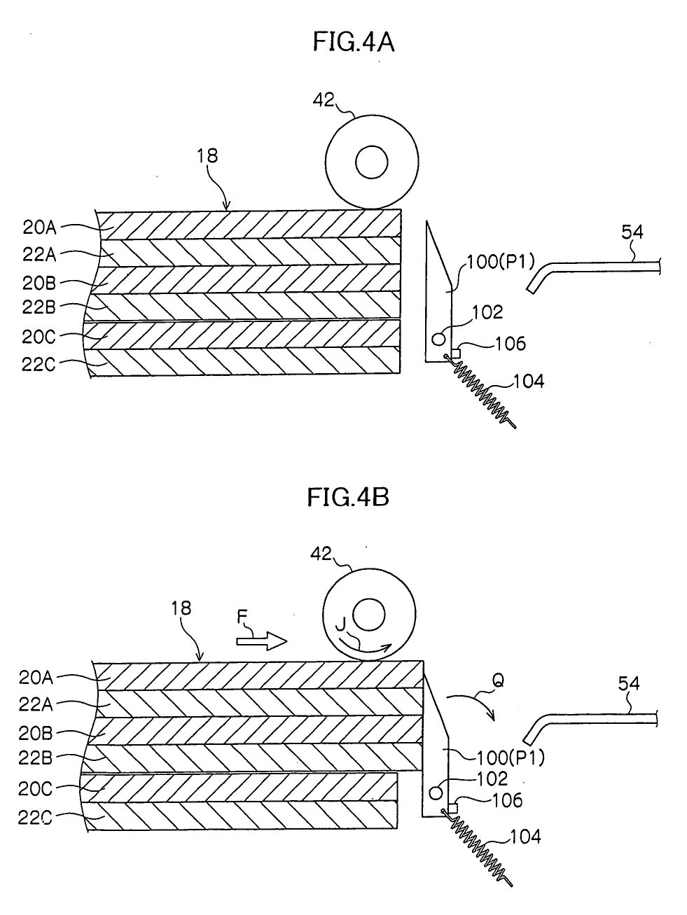

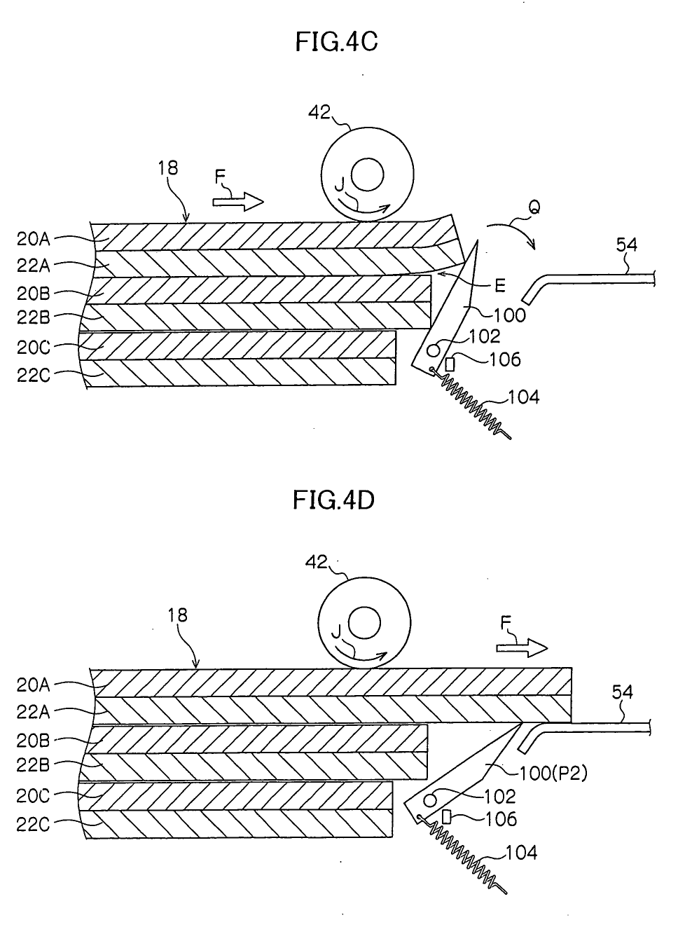

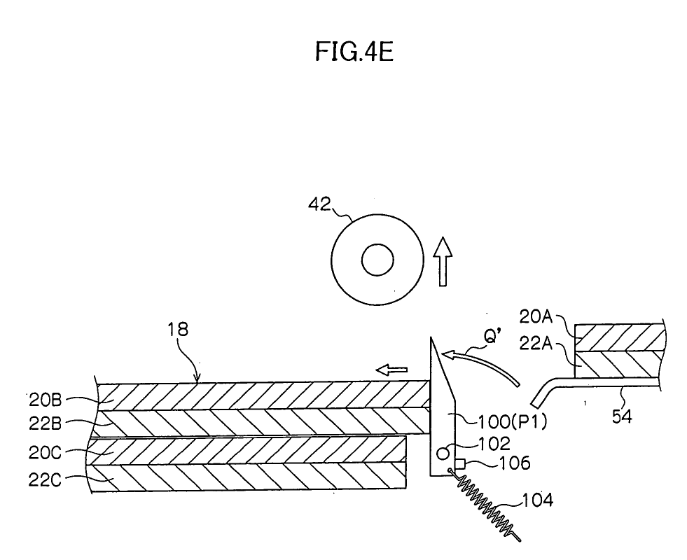

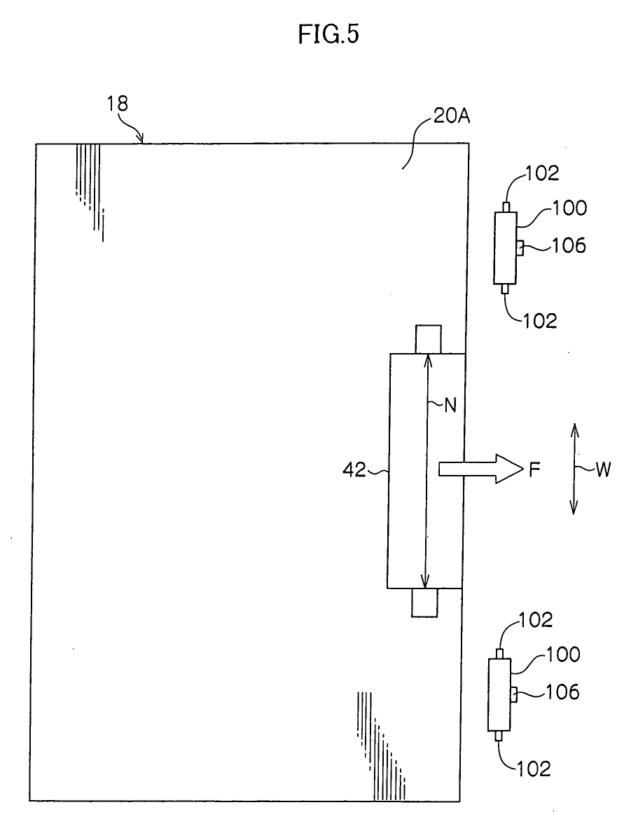

As shown in FIG. 4A to FIG. 4E, leading edge guides 100 are provided, as guides, between the stack of plates 18 mounted on the mounting plate 52 and the guide plate 54. As shown in FIG. 5, the leading edge guides 100 are provided at two positions equidistant from the stack of plates 18. The leading edge guides 100 are provided outside, in the widthwise direction W, of a region N where the pick-up roller 42 and the uppermost planographic printing plate 20 contact each other (which uppermost planographic printing plate 20 will be hereinafter referred to as “planographic printing plate 20A”).

In the contact area N, it is not easy to generate a bending moment, and so even if movement of the uppermost planographic printing plate 20 is prevented by the leading edge guides 100, the planographic printing plate 20 would not be easily bent. On the other hand, a region of the planographic printing plate 20 outside, of the contact area N, in the widthwise direction W, is more easily bent. Accordingly, the leading edge guides 100 are disposed at the aforementioned positions, thereby allowing the uppermost planographic printing plate 20 to be bent easily. As a result, it is possible to facilitate an inflow of air between: the uppermost planographic printing plate 20 and the interleaf paper 22 adhering thereto; and the underlying planographic printing plate 20 and the interleaf paper 22 adhering thereto.

Further, the leading edge guides 100 are provided at a height so that they abut both the planographic printing plate 20A and the underlying planographic printing plate 20 (which will be hereinafter referred to as “planographic printing plate 20B”) when the planographic printing plate 20A and the planographic printing plate 20B are conveyed by the pick-up roller 42 (see FIG. 4A). The leading edge guides 100 can be formed from, for example, POM-based resin or another material. Since the interleaf paper 22 is conveyed together with the uppermost planographic printing plate 20 while making contact with the leading edge guides 100, if the friction between the leading edge guides 100 and the interleaf paper 22 is large, a jam can result. When the leading edge guides 100 are formed from POM-based resin as described above, the interleaf paper 22 easily slides over the leading edge guides 100, thereby making it possible to prevent a jam of the interleaf papers 22.

The portion of the leading edge guides 100 is tapered, at the side closest to the guide plate 54 towards the top, so as to slope down away from the stack of plates 18. Due to the leading edge guides 100 having the aforementioned shape, it is possible to reduce the space required by the leading edge guide 100 for rotation in the conveying direction as described below.

Guide shafts 102 are inserted through the lower portion of the leading edge guides 100 along the widthwise direction W. The leading edge guides 100 are rotatable around the guide shafts 102. Further, one end of a helical tension spring 104, serving as urging means, is mounted at the lower end of the leading edge guides 100. The other end of the helical tension spring 104 is fixed at a stationary portion (not shown), and the helical tension spring 104 generates torque in the leading edge guides 100, with the guide shaft 102 serving as a fulcrum. As a result, the leading edge guides 100 are urged to the upstream side with respect to the conveying direction, that is, against the side of the stack of plates 18. The leading edge guides 100 when in the state of not being pressed, are restrained from rotating by abutting stoppers 106, serving as position retention members, and the surfaces of the leading edge guides 100 facing the stack of plates 18 are held in reference position P1, that is parallel to the stack of plates 18 (see FIG. 4A). When the leading edge guides 100 are pressed from the upstream side, with respect to the conveying direction, they are induced to incline by rotating around the guide shafts 102 in the direction indicated by arrow Q, and the helical tension springs 104 extend. The direction indicated by arrow Q has a component in the vertical direction towards the lower side of the stack of plates 18. The leading edge guides 100 are rotated in the direction indicated by arrow Q to a position at which the planographic printing plate 20A and the interleaf paper 22A can be moved to the downstream side of the leading edge guided 100, with respect to the conveying direction (which position will be hereinafter referred to as “retracted position P2”), see FIG. 4D.

As shown in FIG. 1, an interleaf paper separating device 58 is disposed between the guide plates 54 and 56. The interleaf paper separating device 58 has a conveying roller unit 60 and a retarding roller unit 62, which are sequentially disposed in the conveying direction F. Each of the roller units, as shown in FIG. 2, is formed by a shaft 64, that is rotatable and spans along the widthwise direction W, with a plurality of rubber rollers 66 fixed onto each shaft 64 at predetermined intervals. When rotated by the driving force from a driving motor 61, the rubber rollers 66 of the conveying roller unit 60 rotate in the direction indicated by arrow R1 (forward rotation), and the rubber rollers 66 of the retarding roller unit 62 rotate in the direction indicated by arrow R2, that is opposite to that of R1 (reverse rotation).

The retarding roller unit 62 is moved by a driving unit 68, provided at one end thereof, between a position where it is in contact with the interleaf paper 22 in the state of being conveyed, and a position where it is moved away from the interleaf paper 22. When the retarding roller unit 62 is in contact with the interleaf paper 22, the retarding roller unit 62 is rotated in the reverse direction and, in so doing, the interleaf paper 22 can be separated from the planographic printing plate 20. The rubber rollers 66 of the retarding roller unit 62 also come into contact with the rubber rollers 66 of the conveying roller unit 60 so that the interleaf paper 22 can be nipped between the rubber rollers 66 of the returned roller unit 62 and the rubber rollers 66 of the conveying roller unit 60.

A nip roller 70 is provided spanning above the conveying roller unit 60 in the widthwise direction in a rotatable manner. The nip roller 70 comes into contact with the planographic printing plate 20, due to its own weight, in such a manner as to be capable of nipping the planographic printing plate 20 and the interleaf paper 22 between itself and the rubber rollers 66 of the conveying roller unit 60.

Interleaf paper conveying roller units 72A and 72B are disposed below the conveying roller unit 60 and the retarding roller unit 62, respectively. The interleaf paper conveying roller units 72A and 72B are also each formed in the same manner as the conveying roller unit 60 and the retarding roller unit 62, with shafts 64 and rubber rollers 66. The interleaf paper 22 can hence be nipped between the rubber rollers 66 of the interleaf paper conveying roller units 72A and 72B, and with the rotation of the rubber rollers 66 of the interleaf paper conveying roller units 72A and 72B, the interleaf papers 22 are nipped therebetween and can be conveyed downward along conveying belts 74.

Provided below the interleaf paper conveying roller units 72A and 72B is an accumulating box 76, in which the interleaf papers 22 are accumulated.

Next, the operation of the present embodiment will be described.

When planographic printing plates 20 are fed into an exposure apparatus using the planographic printing plate feeding apparatus 12 with the structure described above, first, the stack of plates 18 is mounted in the mounting portion 14. At this time, the stack of plates 18 is aligned in such a manner that the trailing edge 18B of the stack 18 comes into contact with the trailing edge guide plate 34, and the side edges of the stack 18 come into contact with the side-edge guide plates 32.

When the planographic printing plate feeding apparatus 12 is mounted at a predetermined position in the exposure apparatus, as shown in FIG. 1, the cover 36A rotates upwards and a portion of the stack of plates 18 (in the vicinity of the front end thereof) is uncovered. When the holder 40 is driven by the driving unit 50, the pick-up roller 42 is brought into contact with the stack of plates 18 (see FIG. 4A).

When the pick-up roller 42 is rotated in the direction indicated by arrow J from the aforementioned state, the planographic printing plate 20A and the interleaf paper 22A are conveyed in the conveying direction F. At this time, if the planographic printing plate 20A and the planographic printing plate 20B are made to closely adhere to each other by a vacuum effect, or if air flows into the region between the planographic printing plate 20B and the underlying planographic printing plate 20C, then the underlying planographic printing plate 20B and the interleaf paper 22B are also conveyed in the conveying direction F together with the uppermost planographic printing plate 20A and the interleaf paper 22A, as shown in FIG. 4B. The planographic printing plate 20A and the interleaf paper 22A adhering thereto, and the planographic printing plate 20B and the interleaf paper 22B adhering thereto are made to abut against the leading edge guides 100 disposed at reference position P1.

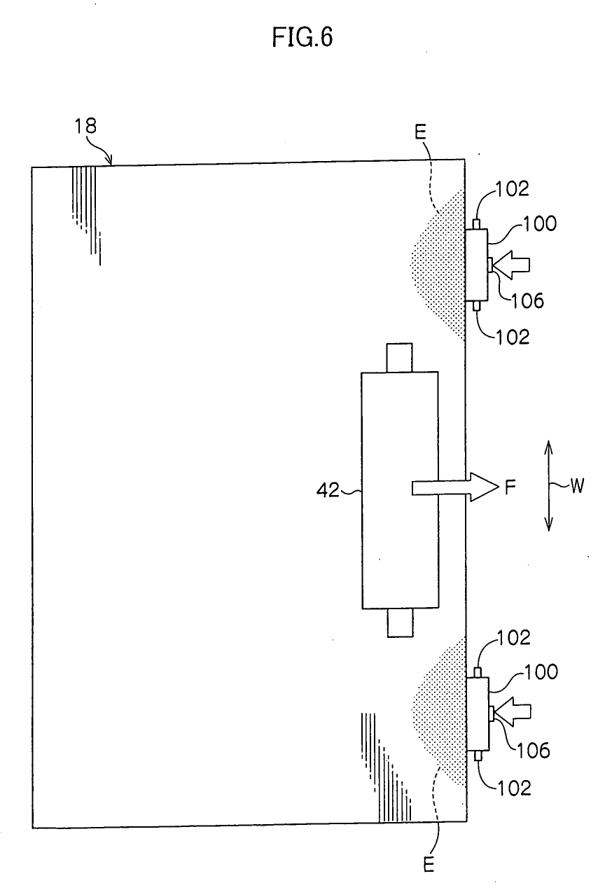

When the pick-up roller 42 is further rotated in the direction indicated by arrow J, the leading edge guides 100 are pressed by the planographic printing plate 20A and the planographic printing plate 20B and rotate in the direction indicated by arrow Q (see FIG. 4C). At this time, the leading edge portions of the planographic printing plate 20A and the planographic printing plate 20B are bent due to a reaction force from the leading edge guides 100. Due to the difference of curvature between the planographic printing plate 20A and the planographic printing plate 20B, air E flows into a region between the planographic printing plate 20A and the planographic printing plate 20B, as also shown in FIG. 6. Due to the inflow of air E, the planographic printing plate 20A (with interleaf paper 22A) and the planographic printing plate 20B (with interleaf paper 22B) are easily separated from each other. In the present embodiment, the leading edge guides 100 are provided outside, in the widthwise direction W, of the contact area N in which the pick-up roller 42 and the planographic printing plate 20A are in contact with each other. Therefore, as compared with a case in which the leading edge guides 100 are provided inside of the contact area N, the leading edge of the planographic printing plate 20A is more easily bent, and a greater inflow of air E can be achieved.

From the aforementioned state, the leading edge guides 100 are further rotated in the direction indicated by arrow Q, by being pressed by the planographic printing plate 20A. Leading edge guides 100 are hence retracted to position P2, thereby allowing the planographic printing plate 20A and the interleaf paper 22A to move past the leading edge guides 100 (see FIG. 4D). As a result, the planographic printing plate 20A and the interleaf paper 22A are conveyed to the downstream side of the leading edge guides 100, with respect to the conveying direction F. On the other hand, the planographic printing plate 20B and the interleaf paper 22B are separated from the planographic printing plate 20A and the interleaf paper 22A, and are left on the upstream side of the leading edge guide 100 with respect to the conveying direction F.

When the state in which the trailing edges of the planographic printing plate 20A and the interleaf paper 22A move past the leading edge guides 100 is detected by a sensor (not shown), the holder 40 is rotated upwards and the pick-up roller 42 moves away from contact with the stack of plates 18. As a result, the pressing of the leading edge guides 100 by the planographic printing plate 20B is released. This lets the leading edge guides 100 rotate in the direction indicated by arrow Q′, opposite to that of arrow Q, by being pulled by the helical tension spring 104, returning the leading edge guides 100 to the reference position P1 where they abut the stoppers 106. The planographic printing plate 20B and the interleaf paper 22B, being pressed by the leading edge guides 100, are returned towards the stack of plates 18.

According to the present embodiment, the leading edge guides 100 are of a simple structure, not requiring accurate positioning, which enables reliable conveying of only the uppermost planographic printing plate 20A and the interleaf paper 22A adhering thereto.

The interleaf paper 22 is separated from the planographic printing plate 20 in the interleaf paper separating device 58 in such a manner as described below. When it is determined by a sensor (not shown) that the planographic printing plate 20 and the interleaf paper 22 are being conveyed together, the conveying roller unit 60 and the retarding roller unit 62 are rotated and the retarding roller unit 62 is moved upwards. Due to the rubber rollers 66 of the retarding roller unit 62 making contact with the interleaf paper 22 while rotating in the reverse direction, a force from the conveying roller unit 60 (operating in the conveying direction), and a force from the retarding roller unit 62 (operating in the opposite direction) both act on the interleaf paper 22. This enables the separation of the interleaf paper 22 from the planographic printing plate 20. The interleaf paper 22 is conveyed downwards, in a bent and folded condition, while being nipped by the rubber rollers 66 of the conveying roller unit 60 and the rubber rollers 66 of the retarding roller unit 62. The interleaf paper 22 is subsequently discharged into an accumulation box 76. The planographic printing plate 20 is further conveyed in the conveying direction F, and delivered to the exposure apparatus.

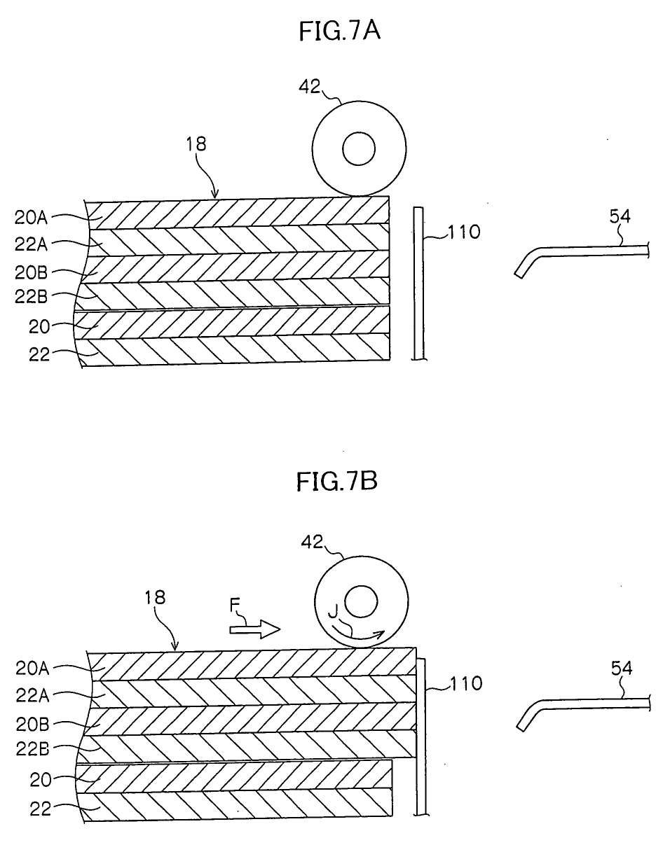

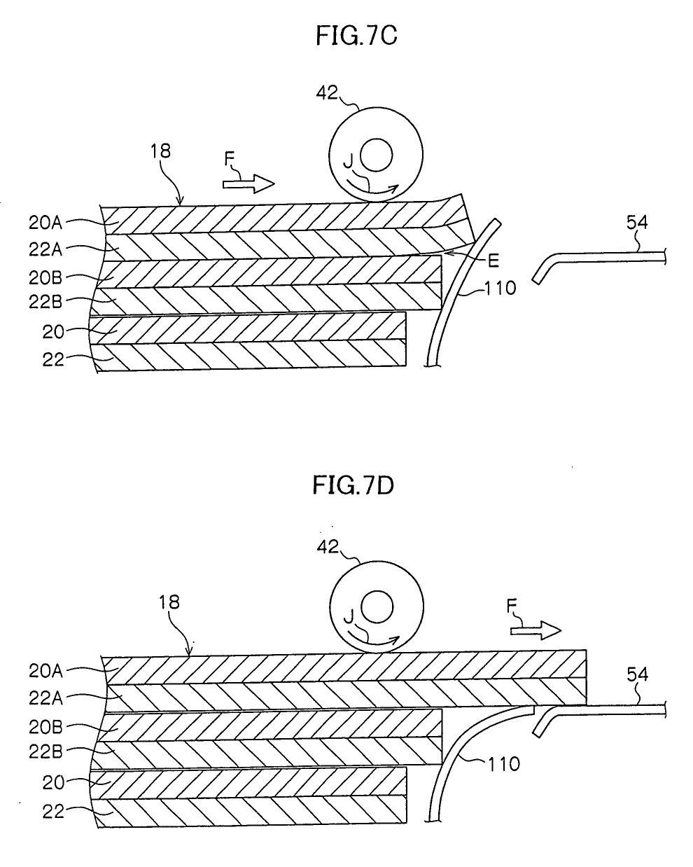

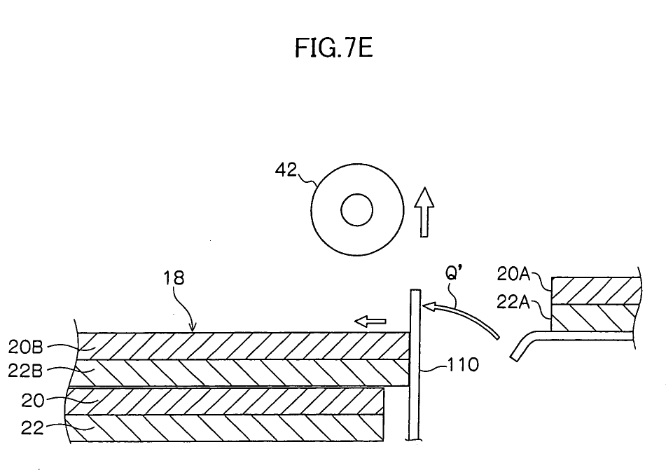

In the present embodiment, an example was described of a structure in which the leading edge guides 100 are made rotatable around the guide shafts 102, and urged by helical tension springs 104 to the upstream side with respect to the conveying direction. However, the leading edge guides are not limited to the same. Alternatively, for example, leading edge guides 110 formed by elastic plates that are elastically deformable, requiring no helical tension spring 104 can be used, as shown in FIGS. 7A to 7E. In this case, lower base end portions of the leading edge guides 110 of the elastic plate leading edge guides 110 are fixed and the upper end portions formed as free ends. A portion of the leading edge guide 110 at the side of the free end is disposed at a height at which it will be able to abut the leading edges of both the planographic printing plate 20A and the planographic printing plate 20B (see FIG. 7A). When the pick-up roller 42 rotates in the direction indicated by arrow J, the planographic printing plate 20A (with the interleaf paper 22A), and the planographic printing plate 20B (with the interleaf paper 22B) are made to abut the leading edge guides 110 (see FIG. 7B). When the pick-up roller 42 further rotates, as shown in FIG. 7C, the leading edge guides 110 are pressed by the planographic printing plate 20A and deform elastically, bending and inclining towards the downstream side with respect to the conveying direction F. When the leading edge guides 110 are further pressed, as shown in FIG. 7D, they permit the planographic printing plate 20A and the interleaf paper 22A to move past. As a result, only the planographic printing plate 20A and the interleaf paper 22A are conveyed to the downstream side of the leading edge guides 110 with respect to the conveying direction. After the trailing edge of the planographic printing plate 20A and the interleaf paper 22A passes over the leading edge guides 110, as shown in FIG. 7E, the leading edge guides 110 return to their original positions, due to the elastic force thereof.

According to the aforementioned structure, leading edge guides that need neither guide shafts nor a helical tension springs, with simpler structures, can be obtained.

What is claimed is:

1. A planographic printing plate feeding apparatus comprising:
a conveyor that conveys an uppermost planographic printing plate and an interleaf paper adhering thereto, using a conveying force to move in a direction in which a planographic printing plate is conveyed while pressing a stack in which planographic printing plates and interleaf papers are alternately stacked; and
a guide member provided at the downstream side of said stack, with respect to the conveying direction, said guide member being provided so as to abut the leading edge of the uppermost planographic printing plate being conveyed so as to bend the planographic printing plate, and allow the uppermost planographic printing plate and interleaf paper to pass over the guide member, while the guide member is being inclined by being pressed by the planographic printing plate.

2. The planographic printing plate feeding apparatus according to claim 1, wherein said guide member is formed including: at least one guide plate that is rotatable around a shaft disposed in a direction parallel to the leading edges of the planographic printing plates; an urging member that urges said guide plate towards the stack; and at least one position retention member that abuts said guide plate, and maintains the position of the guide plate, at a height at which the leading edge of the uppermost planographic printing plate to be conveyed and the upper edge of the guide plate abut.

3. The planographic printing plate feeding apparatus according to claim 2, wherein said guide plate is formed from POM-based resin.

4. The planographic printing plate feeding apparatus according to claim 1, wherein said guide member is formed including at least one elastic plate, that is elastically deformable, and the elastic plate has a fixed base end portion, and a free end portion that is located at a height at which it is able to abut the leading edge of the uppermost planographic printing plate to be conveyed.

5. The planographic printing plate feeding apparatus according to claim 1, wherein said guide member is disposed outside of the position at which the conveyor and the uppermost planographic printing plate contact each other, in a direction orthogonal to the conveying direction of the planographic printing plates.

6. The planographic printing plate feeding apparatus according to claim 2, wherein said guide member is disposed outside of the position at which the conveyor and the uppermost planographic printing plate contact each other, in a direction orthogonal to the conveying direction of the planographic printing plates.

7. The planographic printing plate feeding apparatus according to claim 3, wherein said guide member is disposed outside of the position at which the conveyor and the uppermost planographic printing plate contact each other, in a direction orthogonal to the conveying direction of the planographic printing plates.

8. The planographic printing plate feeding apparatus according to claim 4, wherein said guide member is disposed outside of the position at which the conveyor and the uppermost planographic printing plate contact each other, in a direction orthogonal to the conveying direction of the planographic printing plates.

9. The planographic printing plate feeding apparatus according to claim 1, wherein said conveyor is formed including a conveying roller that rotates while making contact with the uppermost planographic printing plate.

10. The planographic printing plate feeding apparatus according to claim 2, wherein said conveyor is formed including a conveying roller that rotates while making contact with the uppermost planographic printing plate.

11. The planographic printing plate feeding apparatus according to claim 3, wherein said conveyor is formed including a conveying roller that rotates while making contact with the uppermost planographic printing plate.

12. The planographic printing plate feeding apparatus according to claim 4, wherein said conveyor is formed including a conveying roller that rotates while making contact with the uppermost planographic printing plate.

13. The planographic printing plate feeding apparatus according to claim 5, wherein said conveyor is formed including a conveying roller that rotates while making contact with the uppermost planographic printing plate.

14. The planographic printing plate feeding apparatus according to claim 6, wherein said conveyor is formed including a conveying roller that rotates while making contact with the uppermost planographic printing plate.

15. The planographic printing plate feeding apparatus according to claim 7, wherein said conveyor is formed including a conveying roller that rotates while making contact with the uppermost planographic printing plate.

16. The planographic printing plate feeding apparatus according to claim 8, wherein said conveyor is formed including a conveying roller that rotates while making contact with the uppermost planographic printing plate.
